(19) United States
(12) Patent Application Publication
(10) Pub. No.: US 2014/0203217 A1
(43) Pub. Date: Jul. 24, 2014

(54) METHOD FOR MODIFYING SURFACE OF POWDER AND COMPOSITE CONTAINING SURFACE-MODIFIED POWDER

(71) Applicants: Bing Joe Hwang, TAIPEI (TW); Li-Chyong Chen, TAIPEI (TW); Kuei-Hsien Chen, TAIPEI (TW); Deniz Po Wong, TAIPEI (TW); Han-Ping Tseng, TAIPEI (TW)

(72) Inventors: Bing Joe Hwang, TAIPEI (TW); Li-Chyong Chen, TAIPEI (TW); Kuei-Hsien Chen, TAIPEI (TW); Deniz Po Wong, TAIPEI (TW); Han-Ping Tseng, TAIPEI (TW)

(73) Assignee: National Taiwan University of Science and Technology, TAIPEI (TW)

(21) Appl. No.: 13/945,773

(22) Filed: Jul. 18, 2013

(30) Foreign Application Priority Data
Jan. 24, 2013 (TW) 102102723

(51) Int. Cl. H01M 4/36

(52) U.S. Cl. CPC H01M 4/364
USPC 252/502; 252/182.1

(57) ABSTRACT

A method for modifying a surface of a powder is provided. The method includes steps of providing a polar aprotic solvent; and mixing the polar aprotic solvent with the powder so that the polar aprotic solvent adheres to the surface of the powder.

### CROSS-REFERENCE TO RELATED APPLICATION AND CLAIM OF PRIORITY

The application claims the benefit of the Taiwan Patent Application No. 102102723, filed on Jan. 24, 2013, in the Taiwan Intellectual Property Office, the disclosures of which are incorporated herein in their entirety by reference.

### FIELD OF THE INVENTION

The present invention relates to a powder. In particular, the present invention relates to a surface-modified powder.

### BACKGROUND OF THE INVENTION

An anode of a lithium ion (Li-ion) battery having high power presently commercialized is mostly made of graphite. However, the theoretic electric capacity is only up to about 372 mAh/g. In order to overcome the limitation resulting from the insufficiency of the electric capacity, studies to find a novel anode are widely developing. In particular, the studies of alloy systems of both a tin-based material (Sn: 998 mAhlg and SnO₂: 780 mAh/g) and a silicon-based material (Si: 4200 mAh/g) possess high potential for development. The attractiveness of using silicon-based material as anode in Li-ion battery is its abundance on the earth's crust and its intrinsically high theoretical capacity (4200 mAh/g). However, due to the fact that the volume expansion during charging and discharging of the battery is up to about 300%, the anode tends to deteriorate and break so that the structure of the anode is easily fractured and pulverized. Furthermore, after several cycles of charging and discharging the battery, the electric capacity of the battery is rapidly decreased to an almost fully consumed extent. These disadvantages restrict the material's possible commercial applications.

In order to overcome the problem caused by the high variation in volume, a method commonly used in the technical field is to coat a silicon powder with a conductive carbon. This method can efficiently reduce the shrinkage ratio in volume of the silicon powder and improve the problem of poor conductivity of silicon as well. It would be the most beneficial way for the purpose of cost reduction. Graphene, consisting of carbon, is a mono layer of graphite possessing a perfect sp2 configuration and a two-dimension flat plane structure. Recent progress in research has shown that graphene exhibits a lot of particular properties such as high mechanical strength, high specific surface area, high electron conductivity and good chemical stability, so that it has been used in several applications of energy technology. In the prior art, silicon and graphene were combined in order to prepare a silicon/graphene composite which was applied to the anode of the Li-ion battery. The graphene contained in the composite acts as a buffer layer, improves the poor conductivity of silicon, and improves the stability of the cycle performance of the battery during charging and discharging.

Although the stability of charging and discharging the battery can be improved when silicon powders appear in a form of the composite, the problem presently encountered is that the silicon powders are still unable to be uniformly dispersed on the layers of graphene. This unavoidably causes the deterioration of the electric capacity that accompanies the cycles of charging and discharging the battery.

A surfactant modification method or a chemical functionalization method can be used to improve the poor dispersion of silicon on the graphene layers. However, those methods increase the material and manufacturing costs considerably. Therefore, it is urgent to provide a simple, low-cost method to improve the dispersion of silicon powder.

### SUMMARY OF THE INVENTION

In accordance with an aspect of the present invention, a method for modifying a surface of a powder is provided. The method includes steps of providing a polar aprotic solvent; and mixing the polar aprotic solvent with the powder in such a way that the polar aprotic solvent adheres to the surface of the powder.

Furthermore, the polar aprotic solvent has a dielectric constant not smaller than 5 and causes the surface of the powder to have a zeta potential not smaller than 20 mV.

Furthermore, the powder is a nano-particle.

Furthermore, the powder is one selected from a group consisting of silicon powder, germanium powder, tin powder and a combination thereof.

Furthermore, the polar aprotic solvent is one selected from a group consisting of N-methyl-2-pyrrolidone, acetonitrile, N-ethyl-2-pyrrolidone, dimethylformamide, ethyl acetate, tetrahydrofuran, dichlormethane, acetone and a combination thereof.

In accordance with another aspect of the present invention, a method for preparing a composite is provided. The method includes steps of (a) providing a polar aprotic solvent, a polar protic solvent, a powder and a graphene oxide; (b) causing the polar aprotic solvent to adhere to the powder; (c) dispersing the graphene oxide in the polar protic solvent; (d) mixing the powder having the aprotic solvent adhering thereto in the polar protic solvent having the graphene oxide; and (e) reducing the graphene oxide into a graphene.

Furthermore, the polar protic solvent is one selected from a group consisting of water, alcohol and a combination thereof.

Furthermore, the alcohol is one selected from a group consisting of ethyl alcohol, isopropyl alcohol and a combination thereof.

Furthermore, the step of reducing the graphene oxide takes place by heating the graphene oxide to a temperature between 500° C. and 700° C.

Furthermore, the powder having the polar aprotic solvent adhering thereto has an absorption intensity higher than 0.5 arbitrary unit measured by UV-Visible spectrophotometer at a wavelength of 600 nm.

Furthermore, the polar aprotic solvent is one selected from the group consisting of N-methyl-2-pyrrolidone, acetonitrile, N-ethyl-2-pyrrolidone, dimethylformamide, ethyl acetate, tetrahydrofuran, dichlormethane, acetone and a combination thereof.

Furthermore, the polar aprotic solvent has a dielectric constant not smaller than 5.

Furthermore, the powder having the polar aprotic solvent adhering thereto has a surface having a zeta potential not smaller than 20 mV.

Furthermore, the powder and the graphene oxide are mixed in a weight ratio, and the weight ratio is in the range of 0.5˜9:1.

Furthermore, the surface of the powder has an oxide formed thereon, and further includes a step of (f) removing the oxide formed on the surface of the powder.

In accordance with a further aspect of the present invention, a composite containing graphene is provided. The composite containing graphene includes a graphene; and a powder having a polar aprotic solvent adhering thereto.

Furthermore, the powder has a weight percentage of 10% to 90% in the composite.

Furthermore, the polar aprotic solvent is one selected from a group consisting of N-methyl-2-pyrrolidone, acetonitrile, N-ethyl-2-pyrrolidone, dimethylformamide, ethyl acetate, tetrahydrofuran, dichlormethane, acetone and a combination thereof.

Furthermore, the polar aprotic solvent has a dielectric constant not smaller than 5.

Furthermore, the powder having the polar aprotic solvent adhering thereto has a zeta potential not smaller than 20 mV.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1(A) is a flow diagram according to an embodiment of the present invention;

FIG. 1(B) is a flow diagram according to another embodiment of the present invention;

FIG. 2(A) is a diagram showing a characteristic test result of a cyclic charging and discharging according to an embodiment of the present invention;

FIG. 2(B) is a diagram showing a characteristic test result of a cyclic charging and discharging according to another embodiment of the present invention;

FIG. 3(A) is a diagram showing characteristic test results of cyclic charging and discharging according to an embodiment of the present invention and the prior art;

FIG. 3(B) is a diagram showing characteristic test results of cyclic charging and discharging according to another embodiment of the present invention and the prior art;

FIG. 4 is a diagram showing a zeta potential according to an embodiment of the present invention;

FIG. 5 is a UV-Vis spectrum analysis for the evaluation of dispersion with various combination of dispersing and modifying solvents

FIG. 6 is a schematic diagram showing another characteristic test result of a UV-Visible spectrum analysis.

### DETAILED DESCRIPTION OF THE PREFERRED EMBODIMENT

The present invention will now be described more specifically with reference to the following embodiments. It is noted that the following descriptions of preferred embodiments of this invention are presented herein for the purposes of illustration and description only; it is not intended to be exhaustive or to be limited to the precise form disclosed.

The present invention takes place through a solvent exchange method. This allows some of the dispersing solvent to remain on the surface of a powder, nano-powder, gain, particle, nano-particle or the combination thereof so as to improve the dispersion of the material in a poor solvent environment. The present invention uses a graphene as an initializing material. Graphene has a better dispersion in water. However, silicon particles can hardly be dispersed in water. Silicon powder has a better dispersion in some organic solvents such as N-methyl-2-pyrrolidone (NMP) or in other polar aprotic solvents. First, by using the solvent exchange method, the surface of the silicon particles or nano-particles is treated in a way that some dispersing solvent remains thereon with the result that the silicon particles or nano-particles can be uniformly dispersed in water or in other polar aprotic solvents to form a stably and uniformly dispersed solution. Second, graphene oxides are mixed with the silicon particles treated by the solvent exchange method in water to form a stably and uniformly dispersed solution. Third, the graphene oxide is reduced into graphene to improve the conductivity. Finally, a silicon/graphene composite is prepared accordingly.

In comparison with the prior art, the present invention provides a method, without additionally using surfactant modification or chemical functionalization with the result to cause silicon powder to have a good dispersion in a solvent, resulting in a solution that is more uniformly dispersed. The present invention utilizes the solvent exchange method combined with a high temperature reduction method to effectively reduce the cost required for manufacturing. The advantages of the present invention includes the satisfaction of a low-cost solution process presently pursued by the makers in the field, an effective way to improve the deterioration of electric capacity of the silicon anode by using the composite formed according to the present invention, and a dramatic improvements toward the stability of the battery during the cyclical charging and discharging.

According to one embodiment of the present invention, the first solvent can be a polar aprotic solvent, wherein the polar aprotic solvent can be N-methyl-2-pyrrolidone (NMP). The second solvent can be a polar protic solvent, wherein the polar protic solvent can be water or de-ionized water. The graphene oxide used by the present invention can be prepared by the Hummer method or the modified Hummer method.

The graphene oxide prepared by the Hummer method is obtained by the oxidization of graphite powder treated with a water-free mixture of concentrated sulfuric acid, sodium nitrate and potassium permanganate. The modified Hummer method differs from the Hummer method in that the application ratio of graphite to sodium nitrate is different.

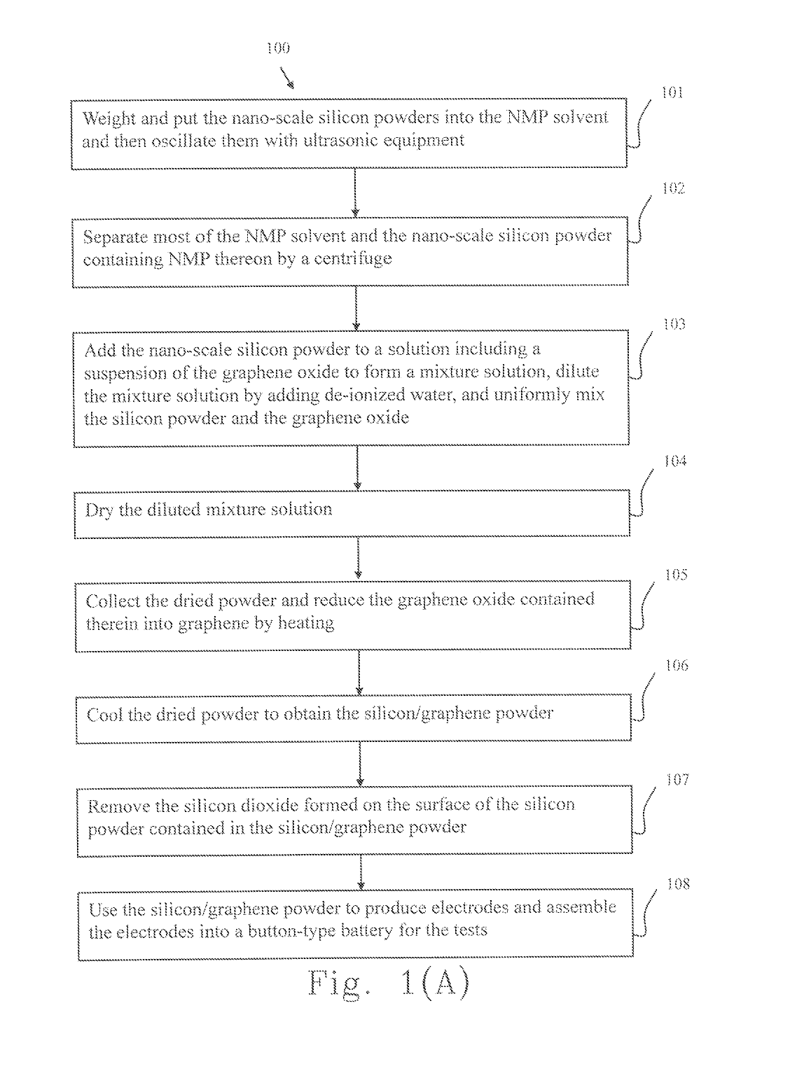

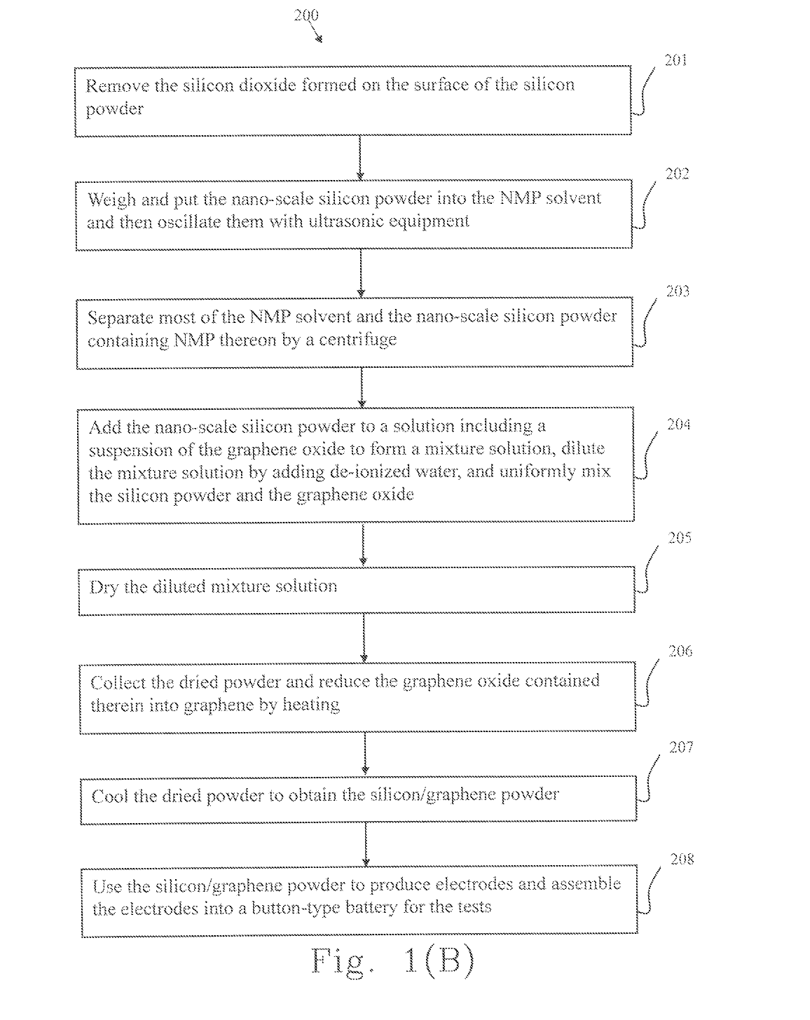

Please refer to FIGS. 1(A)˜1(B). FIG. 1(A) shows a flow diagram according to an embodiment of the present invention. FIG. 1(B) shows a flow diagram according to another embodiment of the present invention. The flow diagram 100 shown in FIG. 1(A) includes the following steps of weighing and putting the nano-scale silicon powder into the NMP solvent in a concentration of 5 mg/ml into a centrifuge tube and then oscillating the tube with ultrasonic equipment for 30 minutes (step 101); separating most of the NMP in the upper part of the suspended solution with a high speed centrifuge under the conditions of 20,000 rpm for 20 minutes at about 25° C., and causing the nano-scale silicon powder containing NMP to be precipitated to the bottom in the centrifuge tube (step 102); adding the nano-scale silicon powder having the NMP remaining thereon to a solution including a suspension of the graphene oxide prepared as described above in a pre-determined ratio to form a mixture solution, diluting the mixture solution to a concentration of about 5 mg/ml by adding de-ionized water, and stirring and oscillating the diluted mixture solution with ultrasonic equipment to insure a uniform mix of the silicon powder and the graphene oxide contained therein (step 103); drying the diluted mixture solution with a rotary evaporator at about 75° C. (step 104); collecting the dried powder obtained in the rotary evaporator in a crucible, and putting the crucible together with the dried powder into a tube furnace for the purpose of reducing the graphene oxide into graphene by removing the functional group containing oxygen atom adhering to the surface of the graphene oxide at a high temperature and in the presence of a gaseous mixture of hydrogen (5%) and argon (95%) at about 500° C., about 600° C. or about 700° C. with a heating curve of a temperature increase rate at about 2° C. per minute, wherein the heating curve could be a single stage curve or a multiple stage one (step 105); naturally cooling to room temperature to obtain the silicon/graphene powder (step 106); removing the silicon dioxide formed on the surface of the silicon powder by applying a 5% hydrofluoric acid solution prepared with water and ethyl alcohol in a volumetric ratio of 1:1 and ultrasonic oscillation for 1 hour to the silicon/graphene powder (step 107); and using the obtained silicon/graphene powder to produce electrodes and assembling the electrodes into a button-type battery for the charging and discharging tests (step 108).

Please refer to FIG. 1(B), wherein the step of removing the silicon dioxide formed on the surface of silicon powder takes place in the first step. The flow diagram 200 shown in FIG. 1(B) includes the following steps of removing the silicon dioxide formed on the surface of the nano-scale silicon powder by putting the nano-scale silicon powder into a 5% hydrofluoric acid solution prepared with water and ethyl alcohol in a volumetric ratio of 1:1 and performing ultrasonic oscillation for 1 hour (step 201); weighing and putting the nano-scale silicon powder with NMP solvent in a concentration of 5 mg/ml into a centrifuge tube and then oscillating the tube with ultrasonic equipment for 30 minutes (step 202); separating most of the NMP in the upper part of the suspended solution by a high speed centrifuge under the conditions of 20,000 rpm for 20 minutes at about 25° C., and causing the nano-scale silicon powder containing NMP thereon to be precipitated to the bottom in the centrifuge tube (step 203); adding the nano-scale silicon powder having the NMP remaining thereon into a solution including a suspension of the graphene oxide prepared as described above in a predetermined ratio to form a mixture solution, diluting the mixture solution to a concentration of about 5 mg/ml by adding de-ionized water, and stirring and oscillating the diluted mixture solution with ultrasonic equipment to insure a uniform mix of the silicon powder and the graphene oxide contained therein (step 204); drying the diluted mixture solution with a rotary evaporator at about 75° C. (step 205); collecting the dried powder obtained in the rotary evaporator in a crucible, and putting the crucible together with the dried powder into a tube furnace for the purpose of reducing the graphene oxide into graphene by removing the functional group containing oxygen atom adhering to the surface of the graphene oxide at a high temperature and in the presence of a gaseous mixture of hydrogen (5%) and argon at about 500° C., about 600° C. or about 700° C. with a heating curve of a temperature increase rate at about 2° C. per minute, wherein the heating curve could be a single stage curve or a multiple stage one (step 206); naturally cooling to room temperature to obtain the silicon/graphene powder (step 207); and using the obtained silicon/graphene powder to produce electrodes and assembling the electrodes into a button-type battery for the charging and discharging tests (step 208).

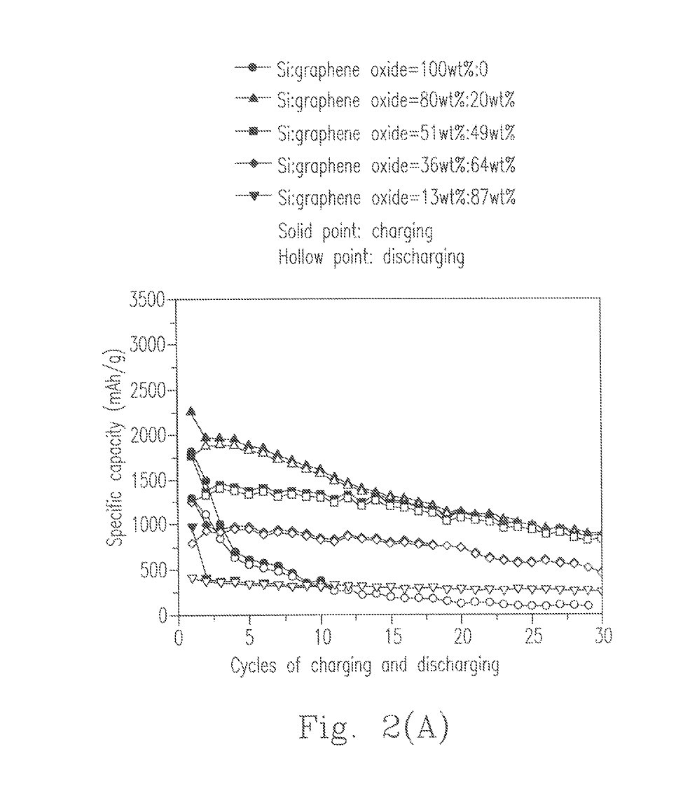

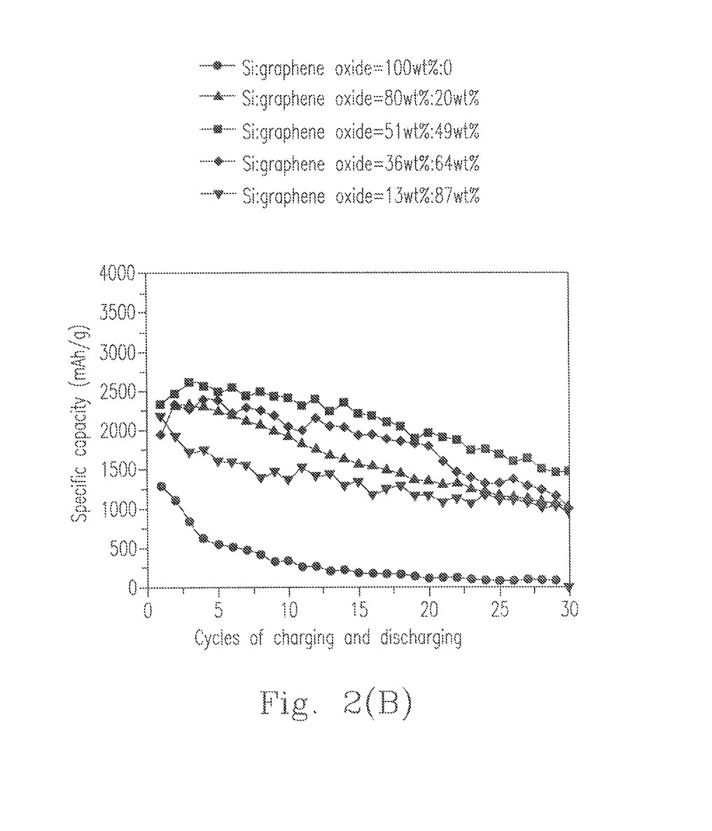

FIG. 2(A) shows a schematic diagram showing the characteristic properties of a cyclical charging and discharging process according to an embodiment of the present invention. The present invention takes advantage of adjusting the ratio of silicon powder to graphene oxide to get the optimal electric capacity and stable charging and discharging efficiency. Under the stability test, a specific capacity is obtained by dividing the electrical capacity of a mixture by the total weight and is to be a comparable reference. As shown in FIG. 2(A), a variety of the ratios of nano-scale silicon powder to graphene oxide are performed so that different silicon/graphene composites are produced. After the cyclical charging and discharging tests run for 30 cycles, the obtained electrical capacity curves of all electrodes made from the silicon/graphene composites are obviously different. The solid points in the curves represent the data measured when charging the battery, while the hollow points represent the data measured when discharging the battery. It is observed from FIG. 2(A) that the deterioration ratio of the specific capacity is much higher when the weight percentage of the nano-scale silicon powder in the composite is higher than 50%. On the contrary, the deterioration ratio of the specific capacity is much lower when the weight percentage of the nano-scale silicon powder contained in the silicon/graphene composite is lower than 50%. The data are summarized in Table 1. It is seen that when the weight percentage of the nano-scale silicon powder contained in the silicon/graphene composite is in a range about 10% to 90%, or especially of about 20% to 80%, better characteristics of the cyclical charging and discharging process is acquired.

TABLE 1

| | Content of silicon | | Electric capacity | |
|---|---|---|---|---|
| Mixing ratio | in composite | Initial | after 30 cycles | Dete- |
| of silicon: | (weight percent), | electric | of charging and | riora- |
| graphene oxide | Using solvent | capacity | discharging | tion |
| (weight ratio) | exchange method | (mAh/g) | (mAh/g) | ratio |
| 1:0 | Si 100% | 1284 | 87 | 93% |
| 9:1 | Si 80% | 1764 | 843 | 52% |
| 3.5:1 | Si 51% | 1250 | 850 | 32% |
| 1.5:1 | Si 36% | 791 | 448 | 43% |
| 0.5:1 | Si 13% | 404 | 244 | 40% |

As shown in FIG. 2(B), based on the reference of the specific capacity of the nano-scale silicon powder and normalizing the value to weight of the silicon, it is observed that when the weight percentage of the nano-scale silicon powder and the reduced graphene contained in the composite is 51%:49%, i.e. close to about 1:1, the optimal efficiency of a lithium ion battery is obtained.

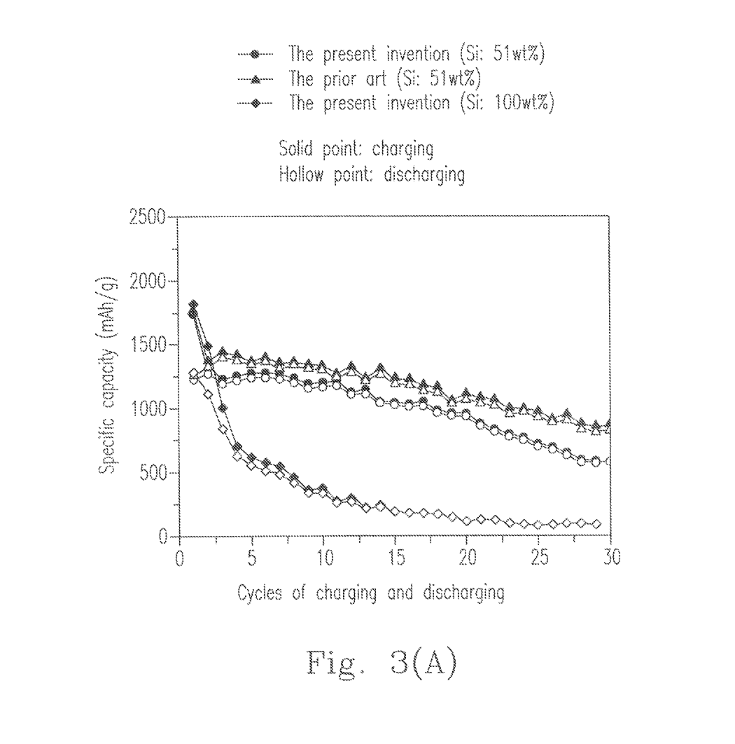

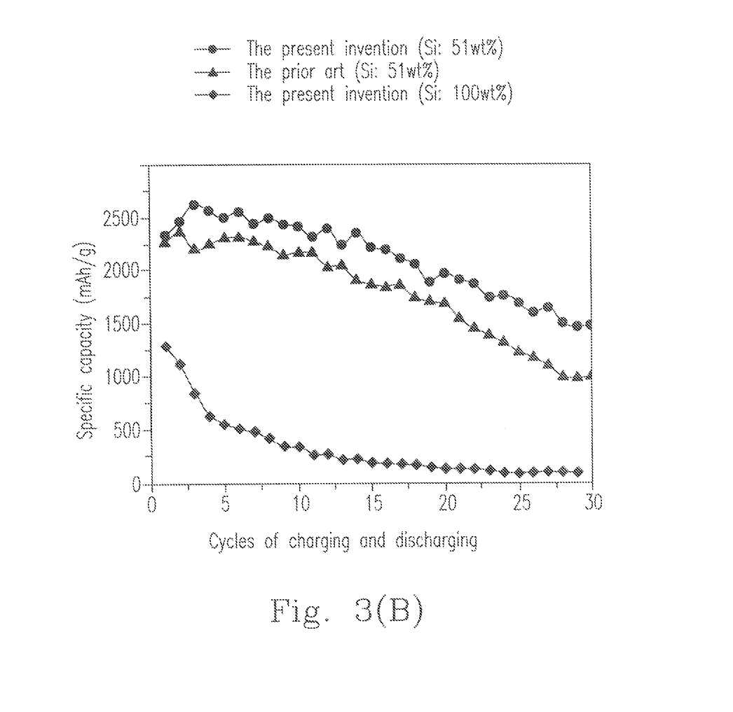

Please refer to FIGS. 3(A) and 3(B), wherein FIG. 3(A) is a schematic diagram showing characteristic test results of the cyclic charging and discharging according to an embodiment of the present invention vs. the prior art, and FIG. 3(B) is a schematic diagram showing characteristic test results of the cyclic charging and discharging according to another embodiment of the present invention vs. the prior art. Both FIG. 3(A) and FIG. 3(B) show the specific capacity based on the references of the unit weight of the total mixture and that of the nano-scale silicon powder. Three kinds of silicon/graphene composite samples were manufactured for comparing and evaluating their characteristics. Those three samples were manufactured respectively by (1) using the solvent exchange method of the present invention in which the content of the silicon powder in the composite was about 51 wt %; (2) using the prior art without using the solvent exchange method in which the content of the silicon powder in the composite was about 51 wt %, and (3) using the solvent exchange method in which the content of silicon powder in the composite was 100%. All of the samples were tested by 30 cycles of the charging and discharging process. The specific capacity of the samples before and after the tests are summarized and shown in Table 2. It is clear that the specific capacity of the 32% deterioration ratio of the composite of the present invention is superior than that of the 46% deterioration of the prior art. The improvements and the functions provided by the present invention are confirmed accordingly.

TABLE 2

| | | | Electric capacity | |
|---|---|---|---|---|
| Mixing ratio | | Initial | after 30 cycles | Dete- |
| of silicon: | Content of silicon | electric | of charging and | riora- |
| graphene oxide | in composite | capacity | discharging | tion |
| (weight ratio) | (weight percent) | (mAh/g) | (mAh/g) | ratio |
| 3.5:1 | Si 51% | 1250 | 850 | 32% |
| | treated by solvent | | | |
| | exchange method | | | |
| | (the present | | | |
| | invention) | | | |
| 3.5:1 | Si 51% | 1230 | 570 | 46% |
| | not treated by | | | |
| | solvent exchange | | | |
| | method | | | |
| | (the prior art) | | | |
| 1:0 | Si 100% | 1284 | 87 | 93% |
| | treated by solvent | | | |
| | exchange method | | | |
| | (the present | | | |
| | invention) | | | |

In addition to the aforementioned solvent, NMP, the selection of the modifying solvents could take into consideration some physical properties such as the dielectric constant of a solvent larger than 5, as shown in Table 3, to choose another polar aprotic solvent. For example, choosing acetonitrile, N-Ethyl-2-pyrrolidone (NEP), dimethylformamide (DMF), tetrahydrofuran (THF), dichloromethane (DCM), acetone, or a combination thereof can obtain a similar result.

TABLE 3

| Solvent | Dielectric constant |
|---|---|
| NMP | 32.20 |
| NEP | 28.20 |
| DMF | 38.25 |
| Acetonitrile | 36.64 |
| Ethyl acetate | 6.02 |
| THF | 7.5 |
| DCM | 9.1 |
| Acetone | 21 |

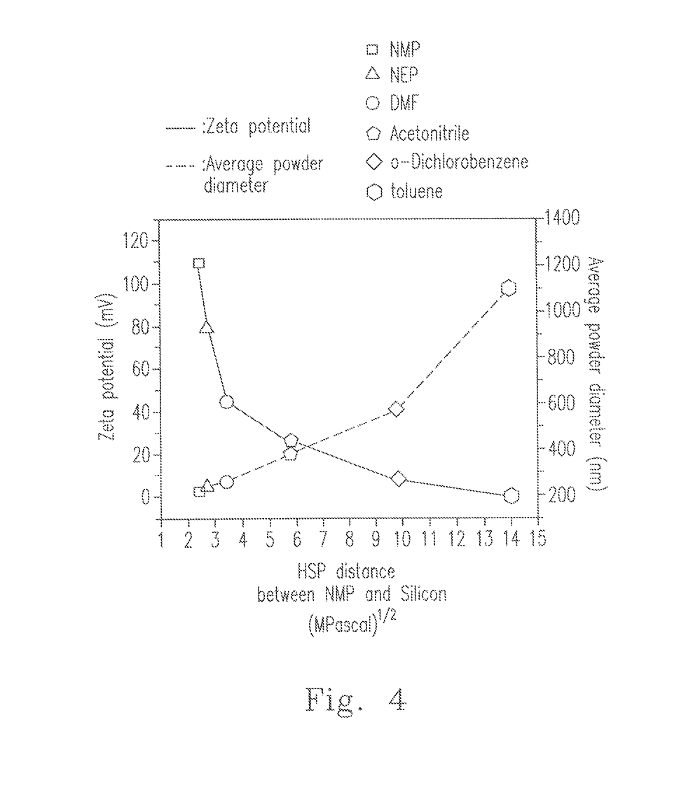

Please refer to FIG. 4, which shows the effect on a surface of the silicon powder modified using a modifying solvent. The left axis is the zeta potential of a powder whose surface was modified by NMP, while the axis on the right is the average diameter of the powder. The abscissa is the Hansen Solubility Parameter (HSP) of different solvents with different powders. According to the measurement results of the zeta potential, it can be seen that the dispersion of nano-scale silicon powder and the zeta potential have a direct relationship. When using NMP to treat the nano-scale silicon powder, the zeta potential of the powder is about 109.5 mV, which represents that the surface possesses a large amount of charge after the treatment of the modifying solvent so that the repulsive forces of the same charge among the powders becomes larger. That is why a good dispersion of the silicon powder is formed and the aggregation of silicon powder does not easily happen. Besides, when HSP is smaller, the stability of the silicon powder dispersed in the solution would improve, the average diameter of the powder in the solution is smaller, which shows a tendency of no aggregation, and the zeta potential would be higher, which shows a stronger repulsive force between powders. Of course, other polar aprotic solvents having a zeta potential higher than about 20 mV can be chosen for the surface modification treatment. The proper solvents chosen as the modifying solvent include at least NMP, NEP, DMF, acetonitrile, and so on.

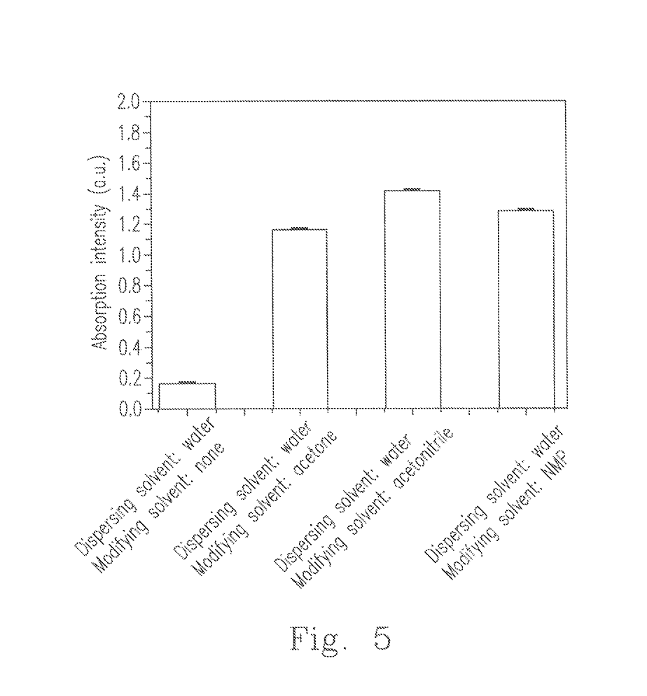

The selection of the modifying solvent can also be decided by referring to the analysis of the UV-Visible spectrophotometer. As shown in FIG. 5, when comparing the absorption spectra of the powder modified by the methods without using a solvent to those using any one of the solvents including NMP, acetone, and acetonitrile, it is found that absorption spectra of the surface-modified powder using NMP, acetone, and acetonitrile would have similar intensities at the wavelength of 600 nm. The measured intensities are about 0.5 arbitrary unit (a.u.) and higher. The measured intensity without using a modifying solvent will be 0.2 a.u. or lower. The difference in whether a modifying solvent is used can be judged accordingly. As shown in Table 3 and FIG. 5, the aforementioned polar aprotic solvents are all appropriate for the surface modification of a powder.

It is observed that the silicon powder, whose surfaces are practically modified by a variety of the aforementioned polar aprotic solvents and dispersed in a polar protic solvent such as water or de-ionized water thereafter, can be effectively suspended in the polar protic solvent without precipitating to the bottom of a beaker. These results prove the effectiveness of the present invention.

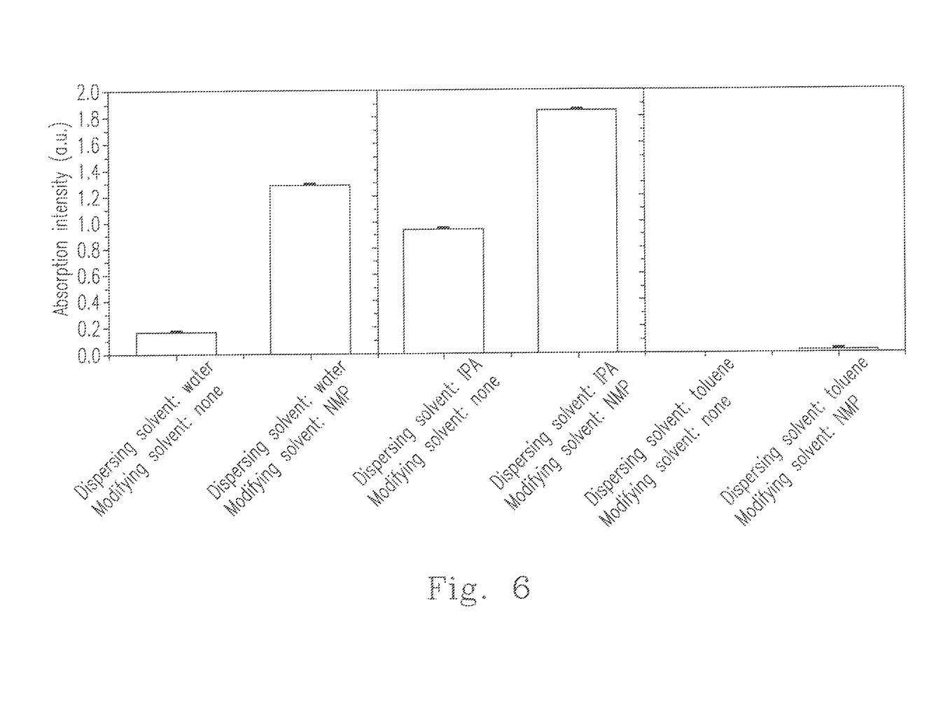

Because the polar solvent is chosen as the modifying solvent in the present invention, the selection of a dispersing solvent must be a polar solvent in cooperation with the modifying solvent so that the surface-modified powder can be easily dispersed by the dispersing solvent. In addition to the de-ionized water serving as a dispersing solvent mentioned in the previous embodiment of the present invention, some other solvents like alcohol, such as isopropyl alcohol (IPA), and benzene, such as toluene, and so on, were also tested. The silicon powder modified by NMP serves as the experimental group and those without modification to serve as a comparative group, and were all dispersed in such dispersing solvents and then analyzed by the UV-Visible spectrophotometer. The results are shown in FIG. 6. When IPA is chosen as the dispersing solvent, the intensity of the absorption spectrum in the 600 nm wavelength is higher than 0.5 a.u. so that the dispersion of the powder modified by NMP is expected to be good when using IPA. When toluene is chosen as the dispersing solvent, the intensity of the absorption spectrum is lower than 0.2 a.u. and therefore the dispersion of the surface-modified powder is expected to be bad. The results obtained from the experiments definitely meet the expectations. Therefore, other polar protic solvents such as ethyl alcohol, IPA, other alcohols or the combination thereof can also be considered as the dispersing solvent of the present invention.

In addition to silicon powder, germanium powder or tin powder which lie in the same group with silicon in the Periodic Table can also be adopted for a similar method for the surface modification and for the preparation of the required composite.

According to other embodiments of the present invention, one skilled in the art can easily understand how to use a non-liquid modifying agent or dispersing agent to replace the liquid one. Furthermore, the powder to be surface-modified can also be replaced by nano-powder, grain, particle, nano-particle, or the combination thereof to generate similar effects and results achieved by using the present invention. Those replacements and modifications to the present invention are still within the idea and the scope of the present invention.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for modifying a surface of a powder, comprising steps of:
providing a polar aprotic solvent; and
mixing the polar aprotic solvent with the powder so that the polar aprotic solvent adheres to the surface of the powder.

2. A method for modifying a surface of a powder according to claim 1, wherein the polar aprotic solvent has a dielectric constant not smaller than 5 and causes the surface of the powder to have a zeta potential not smaller than 20 mV.

3. A method for modifying a surface of a powder according to claim 1, wherein the powder is a nano-particle.

4. A method for modifying a surface of a powder according to claim 1, wherein the powder is one selected from the group consisting of silicon powder, germanium powder, tin powder and a combination thereof.

5. A method for modifying a surface of a powder according to claim 1, wherein the polar aprotic solvent is one selected from the group consisting of N-methyl-2-pyrrolidone, acetonitrile, N-ethyl-2-pyrrolidone, dimethylformamide, ethyl acetate, tetrahydrofuran, dichlormethane, acetone and a combination thereof.

6. A method for preparing a composite, comprising steps of:
(a) providing a polar aprotic solvent, a polar protic solvent, a powder and a graphene oxide;
(b) causing the polar aprotic solvent to be adhered to the powder;
(c) dispersing the graphene oxide in the polar protic solvent;
(d) mixing the powder having the aprotic solvent adhered thereon in the polar protic solvent having the graphene oxide; and
(e) reducing the graphene oxide into a graphene.

7. A method for preparing a composite according to claim 6, wherein the polar protic solvent is one selected from the group consisting of water, alcohol and a combination thereof.

8. A method for preparing a composite according to claim 7, wherein the alcohol is one selected from the group consisting of ethyl alcohol, isopropyl alcohol and a combination thereof.

9. A method for preparing a composite according to claim 6, wherein the step of reducing the graphene oxide is effected by heating the graphene oxide at a temperature between 500° C. and 700° C.

10. A method for preparing a composite according to claim 6, wherein the powder having the polar aprotic solvent adhered thereon has an absorption intensity higher than 0.5 arbitrary unit measured by UV-Visible spectrophotometer at a wavelength of 600 nm.

11. A method for preparing a composite according to claim 6, wherein the polar aprotic solvent is one selected from the group consisting of N-methyl-2-pyrrolidone, acetonitrile, N-ethyl-2-pyrrolidone, dimethylformamide, ethyl acetate, tetrahydrofuran, dichlormethane, acetone and a combination thereof.

12. A method for preparing a composite according to claim 6, wherein the polar aprotic solvent has a dielectric constant not smaller than 5.

13. A method for preparing a composite according to claim 6, wherein the powder having the polar aprotic solvent adhered thereon has a surface having a zeta potential not smaller than 20 mV.

14. A method for preparing a composite according to claim 6, wherein the powder and the graphene oxide are mixed in a weight ratio, and the weight ratio is in the range of 0.5˜9:1.

15. A method for preparing a composite according to claim 6, wherein the surface of the powder has an oxide formed thereon, and the method further comprises a step of (f) removing the oxide formed on the surface of the powder.

16. A graphene-contained composite, comprising:
a graphene; and
a powder having a polar aprotic solvent adhered thereon.

17. A graphene-contained composite according to claim 16, wherein the powder has a weight percentage of 10% to 90% in the composite.

18. A graphene-contained composite according to claim 16, wherein the polar aprotic solvent is one selected from the group consisting of N-methyl-2-pyrrolidone, acetonitrile, N-ethyl-2-pyrrolidone, dimethylformamide, ethyl acetate, tetrahydrofuran, dichlormethane, acetone and a combination thereof.

19. A graphene-contained composite according to claim 16, wherein the polar aprotic solvent has a dielectric constant not smaller than 5.

20. A graphene-contained composite according to claim 16, wherein the powder having the polar aprotic solvent adhered thereon has a zeta potential not smaller than 20 mV.
